(19) United States
(12) Patent Application Publication
(10) Pub. No.: US 2003/0093272 A1
(43) Pub. Date: May 15, 2003

(54) Speech operated automatic inquiry system

(76) Inventors: Frederic Soufflet, Chateaugiron (FR); Nour-Eddine Tazine, Noyal sur Vilaine (FR)

Correspondence Address: Joseph S Tripoli, Patent Operations, Thomson Multimedia Lincensing Inc, CN 5312, Princeton, NJ, 08543-0028, US

(21) Appl. No.: 10/148,301

(22) PCT Filed: Dec. 1, 2000
(86) PCT No.: PCT/FR00/03356

(30) Foreign Application Priority Data
Dec. 2, 1999 (FR) 9915189

(51) Int. Cl. G10L 15/00

(52) U.S. Cl. 704/231

(57) ABSTRACT

The subject of the invention is a process for voice recognition comprising a step of acquiring an acoustic signal, a step of acoustic-phonetic decoding and a step of linguistic decoding.

According to the invention, the linguistic decoding comprises the steps:

of disjoint application of a plurality of language models to the analysis of an audio sequence for the determination of a plurality of sequences of candidate words;

of determination by a search engine of the most probable sequence of words from among the candidate sequences.

The subject of the invention is moreover a device for implementing the process.

The invention relates to a voice recognition process comprising the implementation of several language models for obtaining better recognition. The invention also relates to a device for implementing this process.

Information systems or control systems are making ever increasing use of a voice interface to make interaction with the user fast and intuitive. Since these systems are becoming more complex, the dialogue styles supported are becoming ever more rich, and one is entering the field of very large vocabulary continuous voice recognition.

Large vocabulary voice recognition relies on hidden Markov models, both for the acoustic part and for the language model part.

The recognition of a sentence therefore amounts to finding the most probable sequence of words, given the acoustic data recorded by the mike.

The Viterbi algorithm is generally used for this task.

However, for practical problems, that is to say for example for vocabularies of several thousand words, and even for simple language models of bigram type, the Markov network to be analyzed comprises too many states for it to be possible to apply the Viterbi algorithm as is.

Simplifications are necessary.

A known simplification is the so-called “beam-search” process. The idea on which it relies is simple: in the course of the Viterbi algorithm, certain states of the trellis are eliminated if the score which they obtain is below a certain threshold (the trellis being a temporal representation of the states and of the transitions of the Markov network). This pruning considerably reduces the number of states involved in the comparison in the course of the search for the most probable sequence. A conventional variant is the so-called “N-best search” process (search for the N best solutions), which outputs the n sequences of words which exhibit the highest score.

The pruning used in the course of the N-best search process, which is based on intermediate scores in the left right analysis of the sentence, is sometimes not suited to the search for the best sequence. Two main problems arise:

On the one hand, if this process is tailored to language models of the n-gram type, in which all the information of the language model regarding the strings of words which are most probable is local to the n consecutive words currently analyzed, it is less efficient for language models of the grammar type, which model remote influences between groups of words. It may then happen that the n best sequences retained at a certain juncture of the decoding are no longer possible candidates in the final analysis of the sentence, since the remainder of the sentence invalidates their candidature relative to the sentences with lower score at the outset, but which conform more to the language model represented by the grammar in question.

On the other hand, it frequently happens that an application is developed in modules or in several steps, each module being assigned to specific facilities of the interface, with a priori different language models. In the n-best search process, these various language models are mixed, and as a result of this, if a subpart of the application were to exhibit satisfactory recognition rates, these rates will not necessarily be maintained if new modules are added, even if their field of application is distinct: the two models will interfere with one another.

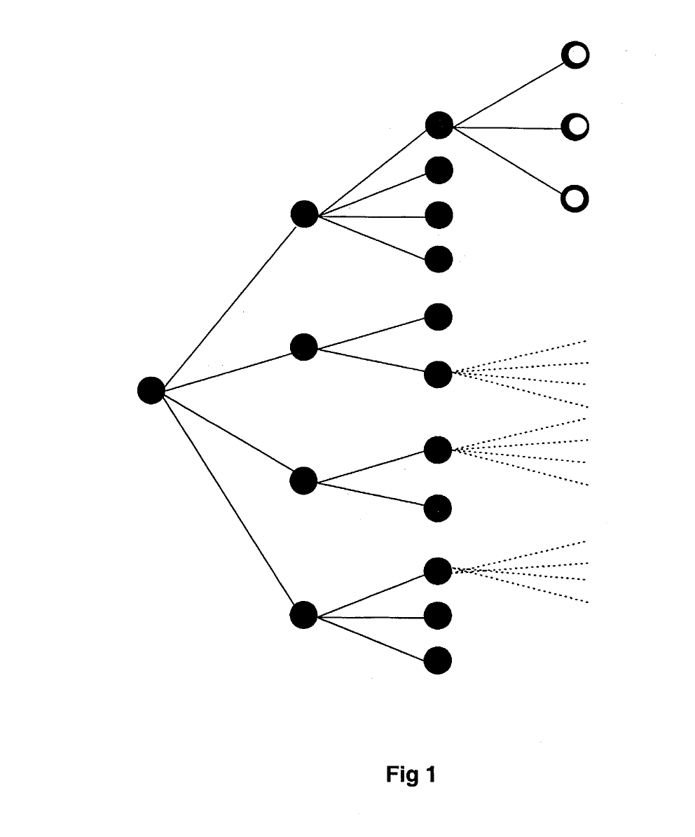

In this regard, FIG. 1 represents a diagram of a language model based on a grammar. The black circles represent decision steps, the lines between these circles model transitions, to which the language model assigns probabilities of occurrence, and the white circles are words of the lexicon, with which are associated Markov networks, constructed by virtue of the phonetic knowledge of their possible pronunciations.

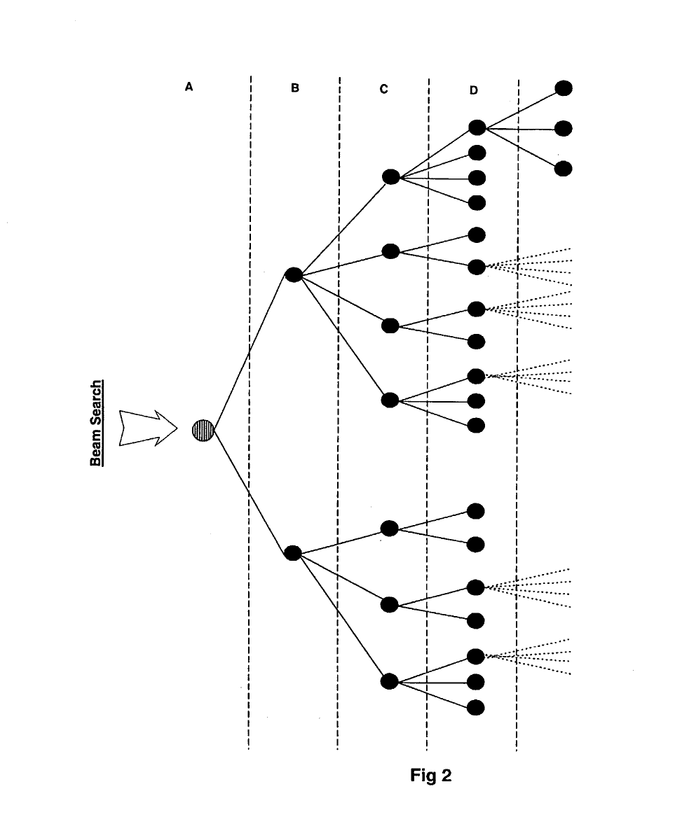

If several grammars are active in the application, the language models of each of the grammars are pooled, to form a single network, the initial probability of activating each of the grammars being customarily shared equally between the grammars, as is described in FIG. 2, where it is assumed that the two transitions departing from the initial node possess the same probability.

Hence, this brings us back to the initial problem of a single language model, and the “beam search” process makes it possible, by pruning the search groups deemed to be the least probable, to find the sentence which exhibits the highest score (or the n sentences in the case of the n-best search).

The subject of the invention is a process for voice recognition comprising a step of acquiring an acoustic signal, a step of acoustic-phonetic decoding and a step of linguistic decoding, characterized in that the linguistic decoding step comprises the steps:

of disjoint application of a plurality of language models to the analysis of an audio sequence for the determination of a plurality of sequences of candidate words;

of determination by a search engine of the most probable sequence of words from among the candidate sequences.

According to a particular embodiment, the determination by the search engine is dependent on parameters which are not taken into account during the application of the language models.

According to a particular embodiment, the language models are based on grammars.

The subject of the invention is also a device for voice recognition comprising an audio processor for the acquisition of an audio signal and a linguistic decoder for determining a sequence of words corresponding to the audio signal

characterized in that the linguistic decoder comprises

a plurality of language models for disjoint application to the analysis of one and the same sentence for the determination of a plurality of candidate sequences,

a search engine for the determination of a most probable sequence from among the plurality of candidate sequences.

Other characteristics and advantages of the invention will become apparent through the description of a particular nonlimiting exemplary embodiment, illustrated by the appended figures among which:

FIG. 1 is a tree diagram schematically representing a grammar-based language model,

FIG. 2 is a tree diagram schematically representing the implementation of a search algorithm on the basis of two language models of the type of FIG. 1 and merged into a single model,

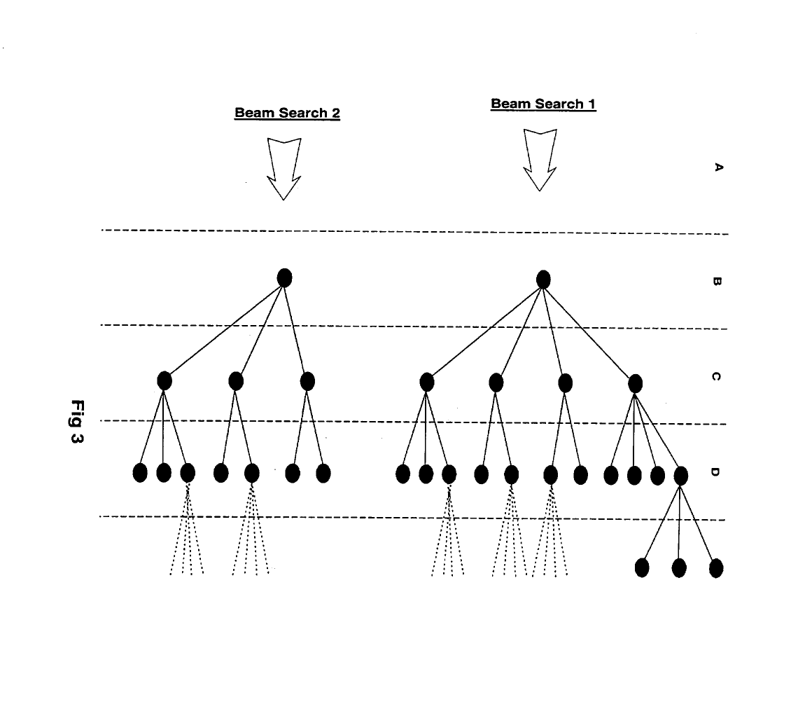

FIG. 3 is a tree diagram of the search process according to the exemplary embodiment of the invention, applied to two language models,

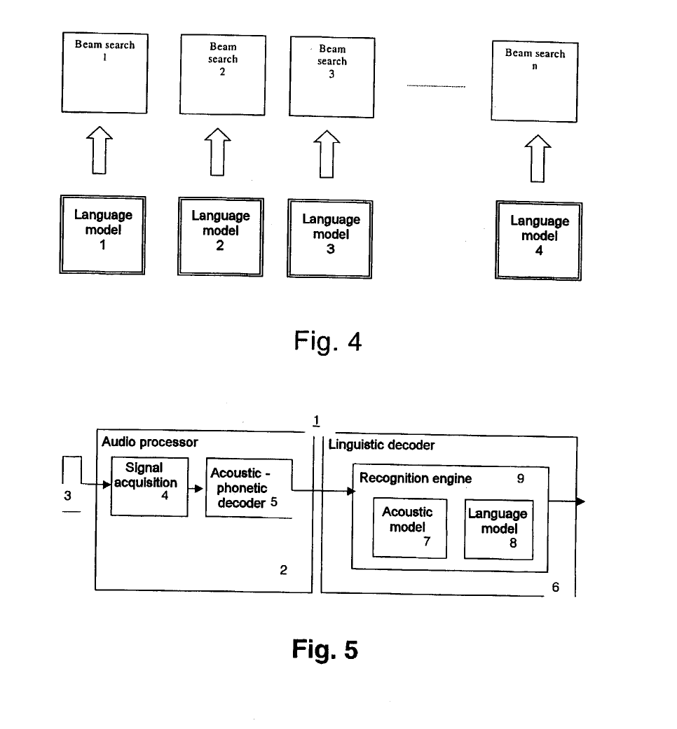

FIG. 4 is a block diagram representing, in accordance with the exemplary embodiment, the use of distinct language models by distinct instances of the search algorithm,

FIG. 5 is a block diagram of a speech recognition device implementing the process in accordance with the present exemplary embodiment.

The solution proposed relies on a semantic pruning in the course of the beam search algorithm: the application is divided into independent modules, each being associated with a particular language model.

For each of these modules, an n-best search is instigated, without a module worrying about the scores of the other modules. These analyses, calling upon distinct items of information, are therefore independent and can be instigated in parallel, and exploit multiprocessor architectures.

We shall describe the invention in the case where the language model is based on the use of grammar, but a language model of n-gram type can also profit from the invention.

For the description of the present exemplary embodiment, we consider the framework of an application in the mass-market sector, namely a television receiver user interface implementing a voice recognition system. The microphone is carried by a remote control, while the audio data gathered are transmitted to the television receiver for voice analysis proper. The receiver comprises in this regard a speech recognition device.

FIG. 5 is a block diagram of an exemplary speech recognition device 1. For the clarity of the account, all the means necessary for voice recognition are integrated into the device 1, even if within the framework of the application envisaged, certain elements at the start of the chain are contained in the remote control of the receiver.

This device comprises a processor 2 of the audio signal carrying out the digitization of an audio signal originating from a microphone 3 by way of a signal acquisition circuit 4. The processor also translates the digital samples into acoustic symbols chosen from a predetermined alphabet. For this purpose it comprises an acoustic-phonetic decoder 5. A linguistic decoder 6 processes these symbols with the aim of determining, for a sequence A of symbols, the most probable sequence W of words, given the sequence A.

The linguistic decoder uses an acoustic model 7 and a language model 8 implemented by a hypothesis-based search algorithm 9. The acoustic model is for example a so-called “hidden Markov” model (or HMM). It is used to calculate acoustic scores (probabilities) of the sequences of words considered in the course of the decoding. The language model implemented in the present exemplary embodiment is based on a grammar described with the aid of syntax rules of the Backus Naur form. The language model is used to guide the analysis of the audio data train and to calculate linguistic scores. The search algorithm, which is the recognition engine proper, is, as regards the present example, a search algorithm based on a Viterbi type algorithm and referred to as “n-best”. The n-best type algorithm determines at each step of the analysis of a sentence the n-sequences of words which are most probable, given the audio data gathered. At the end of the sentence, the most probable solution is chosen from among the n candidates.

The concepts in the above paragraph are in themselves well known to the person skilled in the art, but additional information relating in particular to the n-best algorithm is given in the work:

“Statistical methods for speech recognition” by F. Jelinek, MIT Press 1999 ISBN 0-262-10066-5 pp. 79-84. Other algorithms can also be implemented. In particular, other algorithms of the “beam search” type, of which the “n-best” algorithm is one variant.

The acoustic-phonetic decoder and the linguistic decoder can be embodied by way of appropriate software executed by a microprocessor having access to a memory containing the algorithm of the recognition engine and the acoustic and language models.

According to the present exemplary embodiment, the device implements several language models. The application envisaged being a voice control interface for the command of an electronic program guide, a first language model is tailored to the filtering of the transmissions proposed, with the aim of applying time filters or thematic filters to the database of transmissions available while a second language model is tailored to a change of channel outside of the context of the program guide (“zapping”). It has turned out in practice that acoustically similar sentences could have very different meanings within the framework of the contexts of the two models.

FIG. 4 is a diagram in which the trees corresponding to each of the two models are schematically depicted. As in the case of FIGS. 2 and 3, the black circles represent decision steps, the lines model transitions to which the language model assigns probabilities of occurrence, the white circles represent words of the lexicon with which are associated Markov networks, constructed by virtue of the phonetic knowledge of their possible pronunciations.

Different instances of the beam search process are applied separately to each model. They are not merged but remain distinct, and each instance of the process provides the most probable sentence for the associated model.

According to a variant embodiment, an n-best type process is applied to one or more or all the models.

When the analysis is finished for each of the modules, the best score (or the best scores, depending on the variant) of each module serves for the choice of the sentence which may be understood, conventionally.

According to a variant embodiment, once the analysis has been performed by each of the modules, the various candidate sentences emanating from this analysis are used for a second, finer, analysis phase using for example acoustic parameters which are not implemented in the course of the previous analysis phase.

The processing proposed consists in not forming a global language model, but in maintaining partial language models. Each is processed independently by a beam search algorithm, and the score of the best sequences obtained is calculated.

The invention therefore relies on a set of separate modules, each benefiting from part of the resources of the system, which may propose one or more processors in a preemptive multitask architecture, as illustrated by FIG. 4.

One advantage is that the perplexity of each language model per se is low and that the sum of the perplexities of the n language models present is lower than the perplexity which would result from their union into a single language model. The computer processing therefore demands less computational power.

Moreover, when choosing the best sentence from among the results of the various search processes the knowledge of the language model of origin of the sentence already gives an item of information regarding its sense, and regarding the sector of application attached thereto. The associated parsers can therefore be dedicated to these sectors and consequently be simpler and more efficient.

In our invention, a module exhibits the same rate of recognition, or more exactly, provides the same set of n best sentences and the same score for each, whether it be used alone or with other modules. There is no performance degradation due to merging the models into one.

### References:

Error bounds for convolutional codes and an asymmetrically optimum decoding algorithm. A. J. Viterbi IEEE Transactions on Information Theory, Vol. IT-13, pp. 260-267, 1967.

Statistical methods for speech recognition. F. Jelinek. MIT Press ISBN 0-262-10066-5 pp. 79-84

Perceptual linear prediction (PLP) analysis of speech. Hynek Hermansky Journal of the Acoustical Society of America, Vol. 87, No. 4, 1990, 1738-1752.

1. A process for voice recognition comprising a step of acquiring an acoustic signal, a step of acoustic-phonetic decoding and a step of linguistic decoding, characterized in that the linguistic decoding step comprises the steps:
of disjoint application of a plurality of language models to the analysis of an audio sequence for the determination of a plurality of sequences of candidate words;
of determination by a search engine of the most probable sequence of words from among the candidate sequences.

2. The process as claimed in claim 1, characterized in that the determination by the search engine is dependent on acoustic parameters which are not taken into account during the application of the language models.

3. The process as claimed in one of claims 1 or 2, characterized in that the language models are based on grammars.

4. The process as claimed in one of claims 1 to 3, characterized in that each language model corresponds to a different application context.

5. A device for voice recognition comprising an audio processor (2) for the acquisition of an audio signal and a linguistic decoder (6) for determining a sequence of words corresponding to the audio signal
characterized in that the linguistic decoder comprises
a plurality of language models (8) for disjoint application to the analysis of one and the same sentence for the determination of a plurality of candidate sequences,
a search engine for the determination of a most probable sequence from among the plurality of candidate sequences.
